(19) United States
(12) Patent Application Publication
(10) Pub. No.: US 2025/0162417 A1
(43) Pub. Date: May 22, 2025

(54) Driver Head Position Camera Feed Variability

(71) Applicant: Panasonic Automotive Systems Company of America, Division of Panasonic Corporation of North America, PEACHTREE CITY, GA (US)

(72) Inventor: JOSEPH THOMAS PERRY, OXFORD, MI (US)

(21) Appl. No.: 18/945,750

(22) Filed: Nov. 13, 2024

Related U.S. Application Data
(60) Provisional application No. 63/599,874, filed on Nov. 16, 2023.

(51) Int. Cl. B60K 35/28; B60R 1/12; B60R 1/26; G06F 3/01; G06V 20/56; G06V 20/59; G06V 40/10

(52) U.S. Cl. CPC B60K 35/285; B60R 1/12; B60R 1/26; G06F 3/013; G06V 20/56; G06V 20/597; G06V 40/10; B60K 2360/149; B60K 2360/779; B60R 2001/1215

(57) ABSTRACT

A rearview display arrangement for a motor vehicle includes an eye tracking camera capturing images of a face of a driver of the motor vehicle. A rearview camera captures first images of a scene behind the motor vehicle. A rearview display is mounted in a passenger compartment of the motor vehicle and displays second images based on the first images. An electronic processor is communicatively coupled to the eye tracking camera, to the rearview camera, and to the rearview display. The electronic processor determines locations of eyes of the driver based on the captured images of the face of the driver, and modifies the displayed second images dependent upon the determined locations of the eyes of the driver.

### CROSS-REFERENCED TO RELATED APPLICATIONS

This application claims benefit of U.S. Provisional Application No. 63/599,874, filed on Nov. 16, 2023, the disclosure of which is hereby incorporated by reference in its entirety for all purposes.

### FIELD OF THE INVENTION

The disclosure relates to presenting images within a motor vehicle that have been captured by an external camera.

### BACKGROUND OF THE INVENTION

Some drivers experience motion sickness and disorientation when using vehicles that utilize camera “mirrors” either for rearview or sideview. The motion sickness and disorientation may be due to the camera feeds being static while the driver moves their heads. The driver may try to adjust their head position to see more/different areas of a reflected surface and this leads to a disconnect between what they expect to see and what they actually see.

### SUMMARY

The present invention may perform eye tracking in a camera-based mirror system to determine the position of the driver's head and then dynamically augment the position offset of the camera feeds based on the driver's head position. The invention provides a “parallax” effect (e.g., the changes in perspective that are seen as objects move away from the viewer) that mimics what would be seen in a real mirror and a basic “3D” illusion. This motion offset provides another interaction layer to the driver, bringing the execution of the mirror camera feeds closer to the views provided by a real mirror.

In one embodiment, the invention comprises a rearview display arrangement for a motor vehicle, including an eye tracking camera capturing images of a face of a driver of the motor vehicle. A rearview camera captures first images of a scene behind the motor vehicle. A rearview display is mounted in a passenger compartment of the motor vehicle and displays second images based on the first images. An electronic processor is communicatively coupled to the eye tracking camera, to the rearview camera, and to the rearview display. The electronic processor determines locations of eyes of the driver based on the captured images of the face of the driver, and modifies the displayed second images dependent upon the determined locations of the eyes of the driver.

In another embodiment, the invention comprises a method of operating a rearview display for a motor vehicle, including capturing images of a face of a driver of the motor vehicle. First images of a scene behind the motor vehicle are captured. A rearview display is mounted in a passenger compartment of the motor vehicle. Second images are displayed on the rearview display. The second images are based on the first images. Locations of eyes of the driver are determined based on the captured images of the face of the driver. The displayed second images are modified dependent upon the determined locations of the eyes of the driver.

In yet another embodiment, the invention comprises a rearview display arrangement for a motor vehicle, including an eye tracking camera capturing images of a face of a driver of the motor vehicle. A rearview camera captures first images of a scene behind the motor vehicle. A rearview display is mounted in a passenger compartment of the motor vehicle and displays second images based on the first images. An electronic processor is communicatively coupled to the eye tracking camera, the rearview camera, and the rearview display. The electronic processor determines movements of eyes of the driver based on the captured images of the face of the driver. The displayed second images are modified dependent upon the determined movements of the eyes of the driver such that at least one object in the displayed second images moves in response to the determined movements of the eyes of the driver to match the movements of the object that the driver would see if the rearview display were a rearview mirror.

### BRIEF DESCRIPTION OF THE DRAWINGS

A better understanding of the present invention will be had upon reference to the following description in conjunction with the accompanying drawings.

FIG. 1 is a block diagram of one embodiment of a rearview display arrangement of the present invention for a motor vehicle.

FIG. 2a is a schematic view of the rearview display of the arrangement of FIG. 1 with the driver's eyes in a first position within the eyebox.

FIG. 2b is a schematic view of the rearview display of the arrangement of FIG. 1 with the driver's eyes in a second position within the eyebox.

FIG. 3 is a flow chart of one embodiment of a method of the present invention for operating a rearview display in a motor vehicle.

### DETAILED DESCRIPTION OF THE PREFERRED EMBODIMENTS

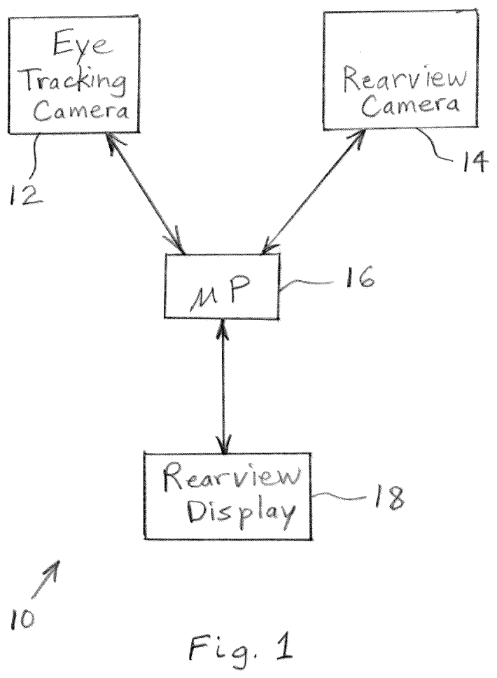

FIG. 1 illustrates one embodiment of a rearview display arrangement 10 of the present invention for a motor vehicle. Arrangement 10 may include a driver monitoring or eye tracking camera 12, a rearview camera 14, an electronic processor 16 and a rearview display 18. Eye tracking camera 12 may capture images of a face of the driver of the motor vehicle.

Rearview camera 14 may be mounted on a rear of the motor vehicle and may capture images of a scene behind the motor vehicle. The images captured by camera 14 may be similar to what the driver would see in a rearview mirror of the motor vehicle if the vehicle had a conventional rearview mirror.

Electronic processor 16 may be a microprocessor and may be in bi-directional communication with each of cameras 12, 14 and display 18. Rearview display 18 may be mounted in approximately the same location in the motor vehicle that a conventional rearview mirror is mounted, namely, near the middle of the top edge of the windshield.

During use, eye tracking camera 12 captures images of the driver's face and transmits the images to processor 16. Similarly, rearview camera 14 captures images of the scene behind the motor vehicle and transmits the images to processor 16. Processor 16 transmits video signals to rearview display 18 based on the images captured by rearview camera 14. Thus, display 18 may present images to the driver that are substantially similar to the images captured by rearview camera 14.

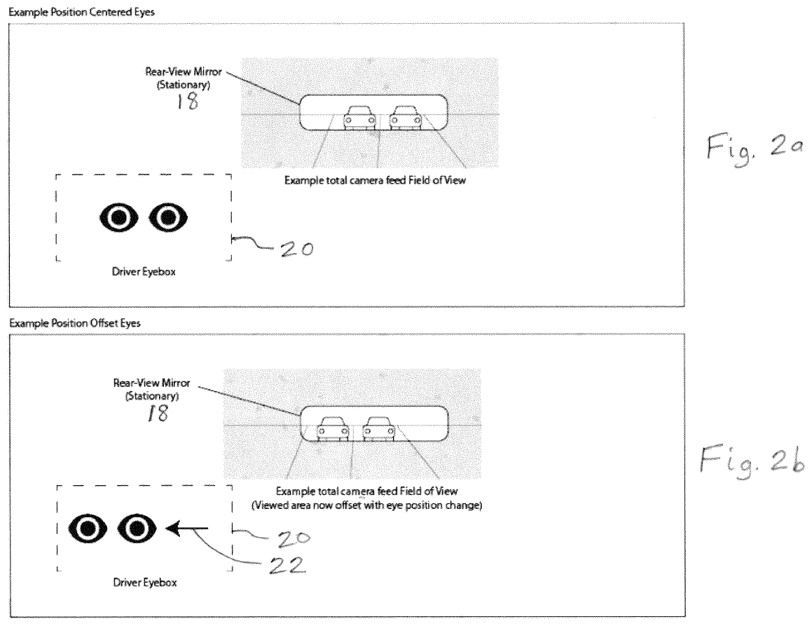

When processor 16 detects in the images from eye tracking camera 12 that the driver has moved his head, then processor 16 may adjust the video signals sent to rearview display 18 so that the images change on rearview display 18 to mimic the changes that the driver would see on a conventional rearview mirror in response to the same movement of his head. FIGS. 2a-b show an example of such a change in the image presented on rearview display 18 in response to a movement of the driver's head. More particularly, FIG. 2a illustrates rearview display 18 with the driver's eyes in a first position, centered within an eyebox 20, looking at display 18. The driver may be sitting in a driver's seat such that the driver's eyes and eyebox 20 are closer to the viewer of FIGS. 2a-b than is rearview display 18. That is, the driver's eyes and eyebox 20 are in the foreground of FIGS. 2a-b, and rearview display 18 is in the background of FIGS. 2a-b.

FIG. 2b illustrates rearview display 18 with the driver's eyes in a second position within eyebox 20. In FIG. 2b, the driver has moved his head and eyes leftward, in the direction of arrow 22, within eyebox 20 from the position of FIG. 2a. In response to the driver moving his eyes leftward, the image presented on rearview display 18 may change in a way that simulates the change that the driver would expect to see on a conventional mirror when he moves his eyes leftward. More particularly, the two cars in the image on rearview display 18 in FIG. 2a have been moved leftward in the image on rearview display 18 in FIG. 2b, as the driver would expect see on a conventional mirror when he moves his head leftward.

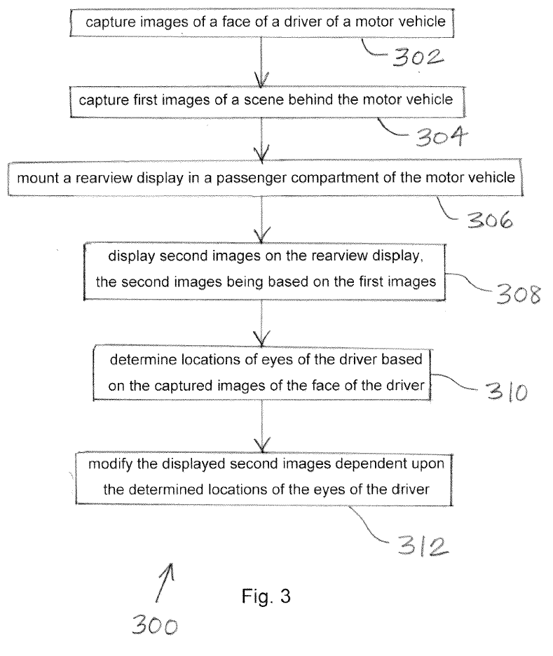

FIG. 3 illustrates one embodiment of a method 300 of the present invention for operating a rearview display in a motor vehicle. In a first step 302, images of a face of a driver of the motor vehicle are captured. For example, eye tracking camera 12 may capture images of a face of the driver of the motor vehicle.

In a next step 304, first images of a scene behind the motor vehicle are captured. For example, rearview camera 14 may capture images of a scene behind the motor vehicle.

Next, in step 306, a rearview display is mounted in a passenger compartment of the motor vehicle. For example, rearview display 18 may be mounted in approximately the same location in the motor vehicle that a conventional rearview mirror is mounted, namely, near the middle of the top edge of the windshield.

In step 308, second images are displayed on the rearview display, the second images being based on the first images. For example, processor 16 transmits video signals to rearview display 18 based on the images captured by rearview camera 14. Thus, display 18 may present images to the driver that are substantially similar to the images captured by rearview camera 14.

Next, in step 310, locations of eyes of the driver are determined based on the captured images of the face of the driver. For example, processor 16 detects in the images from eye tracking camera 12 the location of the driver's face, and may ascertain the locations of the driver's eyes based on the location of his face. Alternatively, processor 16 may directly detect in the images from eye tracking camera 12 the location of the driver's eyes without determining the location of the driver's face.

In a final step 312, the displayed second images are modified dependent upon the determined locations of the eyes of the driver. For example, processor 16 may adjust the video signals sent to rearview display 18 so that the images change on rearview display 18 to mimic the changes that the driver would see on a conventional rearview mirror in response to the same movement of his head.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A rearview display arrangement for a motor vehicle, the arrangement comprising:
an eye tracking camera configured to capture images of a face of a driver of the motor vehicle;
a rearview camera configured to capture first images of a scene behind the motor vehicle;
a rearview display mounted in a passenger compartment of the motor vehicle and configured to display second images based on the first images; and
an electronic processor communicatively coupled to the eye tracking camera, the rearview camera, and the rearview display, the electronic processor being configured to:
determine locations of eyes of the driver based on the captured images of the face of the driver; and
modify the displayed second images dependent upon the determined locations of the eyes of the driver.

2. The rearview display arrangement of claim 1 wherein the rearview display is mounted at a midpoint of a top edge of a windshield of the motor vehicle.

3. The rearview display arrangement of claim 1 wherein the rearview camera is mounted on a rear end of the motor vehicle.

4. The rearview display arrangement of claim 1 wherein the rearview display is substantially planar, and the electronic processor is configured to modify the displayed second images dependent upon an orientation of the rearview display relative to the eyes of the driver.

5. The rearview display arrangement of claim 4 wherein the electronic processor is configured to modify the displayed second images dependent upon a viewing angle between a plane defined by the rearview display and a line of sight from an eye of the driver to the rearview display.

6. The rearview display arrangement of claim 1 wherein the electronic processor is configured to modify the displayed second images such that the displayed second images are shifted on the rearview display in a direction substantially parallel to a direction in which the eyes of the driver have been shifted.

7. The rearview display arrangement of claim 1 wherein the electronic processor is configured to modify the displayed second images such that a size of an object in the displayed second images has a positive relationship with a distance between the rearview display and the eyes of the driver.

8. The rearview display arrangement of claim 1 wherein the electronic processor is configured to determine the locations of eyes of the driver in three-dimensional space.

9. A method of operating a rearview display for a motor vehicle, the method comprising:
capturing images of a face of a driver of the motor vehicle;
capturing first images of a scene behind the motor vehicle;
mounting a rearview display in a passenger compartment of the motor vehicle;
displaying second images on the rearview display, the second images being based on the first images;
determining locations of eyes of the driver based on the captured images of the face of the driver; and
modifying the displayed second images dependent upon the determined locations of the eyes of the driver.

10. The method of claim 9 wherein the rearview display is mounted at a midpoint of a top edge of a windshield of the motor vehicle.

11. The method of claim 9 wherein the first images are captured by a rearview camera mounted on a rear end of the motor vehicle.

12. The method of claim 9 wherein the rearview display is substantially planar, and the displayed second images are modified dependent upon an orientation of the rearview display relative to the eyes of the driver.

13. The method of claim 12 wherein the displayed second images are modified dependent upon a viewing angle between a plane defined by the rearview display and a line of sight from an eye of the driver to the rearview display.

14. The method of claim 9 wherein the displayed second images are modified such that the displayed second images are shifted on the rearview display in a direction substantially parallel to a direction in which the eyes of the driver have been shifted.

15. The method of claim 9 wherein the displayed second images are modified such that a size of an object in the displayed second images has a positive relationship with a distance between the rearview display and the eyes of the driver.

16. The method of claim 9 wherein the locations of the eyes of the driver in three-dimensional space are determined.

17. A rearview display arrangement for a motor vehicle, the arrangement comprising:
an eye tracking camera configured to capture images of a face of a driver of the motor vehicle;
a rearview camera configured to capture first images of a scene behind the motor vehicle;
a rearview display mounted in a passenger compartment of the motor vehicle and configured to display second images based on the first images; and
an electronic processor communicatively coupled to the eye tracking camera, the rearview camera, and the rearview display, the electronic processor being configured to:
determine movements of eyes of the driver based on the captured images of the face of the driver; and
modify the displayed second images dependent upon the determined movements of the eyes of the driver such that at least one object in the displayed second images moves in response to the determined movements of the eyes of the driver to match the movements of the object that the driver would see if the rearview display were a rearview mirror.

18. The rearview display arrangement of claim 17 wherein the electronic processor is configured to modify the displayed second images dependent upon the determined movements of the eyes of the driver such that a size of at least one object in the displayed second images changes in response to the determined movements of the eyes of the driver to match the change in size of the object that the driver would see if the rearview display were a rearview mirror.

19. The rearview display arrangement of claim 17 wherein the rearview display is mounted at a midpoint of a top edge of a windshield of the motor vehicle.

20. The rearview display arrangement of claim 17 wherein the rearview camera is mounted on a rear end of the motor vehicle.

21. The rearview display arrangement of claim 17 wherein the rearview display is substantially planar, and the electronic processor is configured to modify the displayed second images dependent upon an orientation of the rearview display relative to the eyes of the driver.

22. The rearview display arrangement of claim 21 wherein the electronic processor is configured to modify the displayed second images dependent upon a viewing angle between a plane defined by the rearview display and a line of sight from an eye of the driver to the rearview display.

23. The rearview display arrangement of claim 17 wherein the electronic processor is configured to modify the displayed second images such that the displayed second images are shifted on the rearview display in a direction substantially parallel to a direction in which the eyes of the driver have been shifted.

24. The rearview display arrangement of claim 17 wherein the electronic processor is configured to modify the displayed second images such that a size of an object in the displayed second images has a positive relationship with a distance between the rearview display and the eyes of the driver.

25. The rearview display arrangement of claim 17 wherein the electronic processor is configured to determine the locations of eyes of the driver in three-dimensional space.
